(19) United States
(12) Patent Application Publication
(10) Pub. No.: US 2025/0053528 A1
(43) Pub. Date: Feb. 13, 2025

(54) UNIFIED I/O ADDRESS TRANSLATION DATA STRUCTURE

(71) Applicant: International Business Machines Corporation, Armonk, NY (US)

(72) Inventors: Travis J. Pizel, Rochester, MN (US); Naveen Rathi, Ranga Reddy Dist (IN); Swathi Madhuri Bhattiprolu, HYDERABAD (IN)

(21) Appl. No.: 18/447,422

(22) Filed: Aug. 10, 2023

(51) Int. Cl. G06F 13/28; G06F 12/1009

(52) U.S. Cl. CPC G06F 13/28; G06F 12/1009; G06F 2213/28

(57) ABSTRACT

A processor establishes a unified input/output (I/O) translation table including a plurality of translation entries for translating between I/O addresses and memory addresses. I/O addresses specified by direct memory access (DMA) requests received from different I/O adapters each allocated to respective different logical partitions (LPARs) are translated by reference to translation entries in the unified I/O translation table. Physical memory of the data processing system is then accessed based on memory addresses determined by the translation.

### BACKGROUND OF THE INVENTION

The present invention relates in general to data processing, and in particular, to input/output (I/O) address translation in a data processing system.

A data processing system may include multiple processing elements and multiple input/output adapters (IOAs) to support connections to communication networks, storage devices and/or storage networks, and peripheral devices. In such data processing systems, the hardware resources of the data processing system may be logically partitioned into multiple, non-overlapping sets of resources, each controlled by a respective one of multiple possibly heterogeneous operating system instances. The operating systems concurrently execute on this common hardware platform in their respective logical partitions (LPARs) under the control of system firmware, which is referred to as a virtual machine monitor (VMM) or hypervisor. Thus, the hypervisor allocates each LPAR a non-overlapping subset of the resources of the data processing system, and each operating system instance in turn directly controls its distinct set of allocable resources, such as regions of system memory and IOAs.

In current implementations, the I/O address space employed by IOAs is typically virtualized, for example, to promote memory security and ease of memory management. As a consequence, I/O addresses specified by IOAs in direct memory access (DMA) requests must be translated between the virtual I/O address space and the physical (real) address space employed by the data processing system to address system memory. To support I/O address translation, the hypervisor typically implements an I/O translation table for each I/O slot. The size of the I/O translation table for each I/O slot can be individually determined by the hypervisor, often using a complex algorithm that attempts to balance system memory usage and I/O performance.

In cases in which the hypervisor implements relatively small I/O translation tables, the I/O translation tables will be incapable of mapping all of partition memory at any one time. Consequently, in such cases, the operating system can be required to frequently issue calls to the hypervisor to map and unmap I/O translation table entries as different regions of partition memory are accessed by DMA requests. These hypervisor calls can, in aggregate, add significant processing overhead to I/O-heavy workloads and negatively impact I/O performance. The mapping and unmapping of I/O translation table entries can also adversely impact hardware cache performance throughout the data processing system because each time an I/O translation table entry is unmapped all associated I/O address translations based on the unmapped I/O translation table entry must be invalidated in all caches throughout the data processing system that hold the I/O address translations.

In other cases in which the hypervisor implements relatively large I/O translation tables, an operating system running in a logical partition may be able to simultaneously map most or all of partition memory. Doing so can reduce or eliminate the I/O processing overhead of mapping and unmapping I/O translation table entries, resulting in better I/O performance. However, the consumption of large amounts of expensive system memory by large I/O translation tables can be viewed as unacceptable due to the adverse performance impact of memory constraints on non-I/O processing.

The present application additionally recognizes that the implementation of a respective I/O translation table per I/O slot can lead to redundant I/O translation table entries across multiple I/O translation tables. These redundant I/O translation table entries represent an inefficient use of the limited system memory resources.

### SUMMARY OF THE INVENTION

In at least one embodiment, a processor of a data processing system establishes a unified input/output (I/O) translation table including a plurality of translation entries for translating between I/O addresses and memory addresses. I/O addresses specified by direct memory access (DMA) requests received from different I/O adapters each allocated to respective different logical partitions (LPARs) are translated by reference to translation entries in the unified I/O translation table. Physical memory of the data processing system is then accessed based on memory addresses determined by the translation.

In at least one embodiment, the unified I/O translation table is concurrently populated with translation entries sufficient to translate all physical memory addresses in the data processing system.

In at least one embodiment, in response to receiving a particular DMA request initiated by a particular I/O adapter, a base address register (BAR) among a plurality of BARs associated with the particular I/O adapter is selected based on a decode of a particular I/O address specified by the particular DMA request. Based on an address pointer within the BAR, a translation entry among the plurality of translation entries with which to translate the particular I/O address is selected.

In at least one embodiment, based on reassignment of physical memory between LPARs, the address pointer in a BAR is updated.

In at least one embodiment, the relevant BAR for a given DMA request is selected by an I/O host bridge.

In at least one embodiment, multiple different LPARs concurrently executing in a data processing system include a particular LPAR to which a particular I/O adapter among the different I/O adapters is allocated. The particular I/O adapter has an associated plurality of BARs storing address pointers to translation entries in the unified I/O translation table. Based on a request by the an operating system of the particular LPAR to protect a memory region of physical memory allocated to the particular LPAR, at least one of the plurality of BARs is updated to make the memory region inaccessible to DMA requests.

In at least one embodiment, after the unified I/O translation table is established, the data processing system refrains from updating translation entries in the unified I/O translation table.

Aspects of the claimed inventions can be implemented as a method, a data processing system, and as a program product.

### BRIEF DESCRIPTION OF THE DRAWINGS

FIG. 1 is a high level block diagram of an exemplary data processing system in accordance with one embodiment;

FIG. 2 is a logical view of a data processing system showing the hardware and software resources of the data processing system partitioned into multiple concurrently executing logical partitions (LPARs) and the implementation of a unified I/O translation table in accordance with one embodiment;

FIG. 3 is a high-level logical flowchart of an exemplary process by which a hypervisor implements a unified I/O translation table in accordance with one embodiment;

FIG. 4 is a block diagram depicting I/O address translation by reference to a unified I/O translation table in accordance with one embodiment; and

FIG. 5 is a high-level logical flowchart of an exemplary process of translating an I/O address by reference to a unified I/O translation table in accordance with one embodiment.

### DETAILED DESCRIPTION OF ILLUSTRATIVE EMBODIMENT

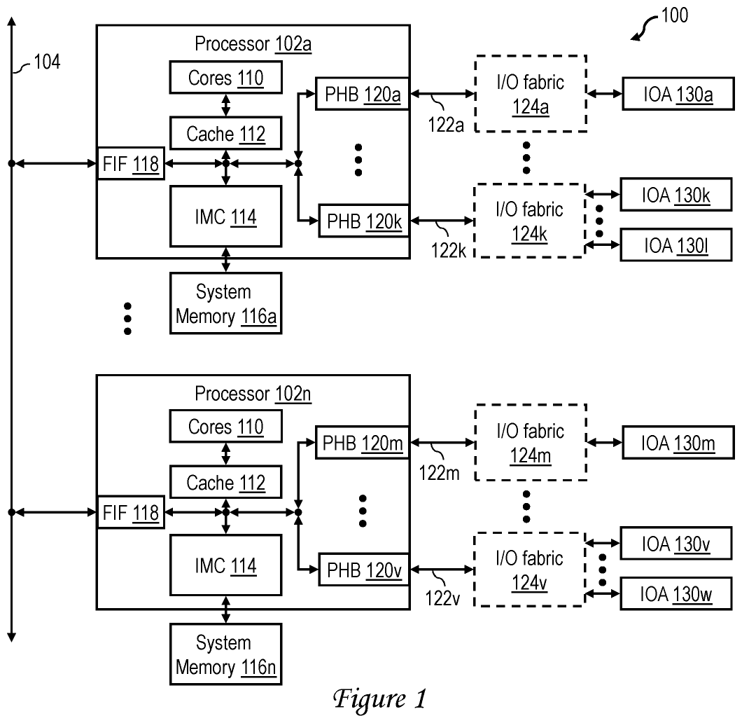

With reference now to the figures, and in particular with reference to FIG. 1, there is illustrated a high-level block diagram of an exemplary data processing system 100 in accordance with one embodiment. In the depicted example, data processing system 100 includes a plurality of processors 102a-102n, each coupled for communication to a system fabric 104, which may include one or more bused or switched communication links. In various implementations, data processing system 100 may be realized as any of variety of computing platforms, such as a mainframe computer, server computer, desktop, laptop or tablet personal computer, mobile phone, embedded computer, automotive computer, etc.

In the depicted embodiment, each processor 102 can be realized as a single integrated circuit chip having a substrate in which semiconductor circuitry is fabricated as is known in the art. As shown, processor 102 includes a plurality of processor cores 110 that process data through the execution and/or processing of program code, which may include, for example, software and/or firmware and associated data, if any. Processor 102 further includes cache memory 112 providing one or more levels of relatively low-latency temporary storage for instructions and data retrieved from lower levels of the data storage hierarchy. In addition, processor 102 includes an integrated memory controller 114 that controls access to a respective associated one of off-chip system memories 116a-116n.

Each processor 102 further includes a fabric interface (FIF) by which processor 102 communicates with system fabric 104, as well as one or more (and preferably multiple) host bridges supporting input/output communication with various input/output adapters (IOAs) 130. In the depicted embodiment, all of the host bridges are implemented as Peripheral Component Interconnect (PCI) host bridges (PHBs) 120, but in other embodiments the host bridges may implement one or more additional or alternative I/O bus standards.

PHBs 120a-120k and 120m-120v provide interfaces to PCI local buses 122a-122k and 122m-122v, respectively, to which IOAs 130, such as network adapters, storage device controllers, peripheral adapters, etc., may be directly connected or indirectly coupled. For example, PCI IOA 130a is coupled to PCI local bus 122a optionally through an I/O fabric 124a, which may comprise one or more switches and/or bridges. In a similar manner, PCI IOAs 130k-130l are coupled to PCI local bus 122k optionally through an I/O fabric 124k, PCI IOA 130m is coupled to PCI local bus 122m optionally through I/O fabric 124m, and PCI IOAs 130v-130w, which may comprise, for example, a display adapter and hard disk adapter, are coupled to PCI local bus 122v optionally through I/O fabric 124v.

Those of ordinary skill in the art will appreciate that the architecture and components of a data processing system can vary between embodiments. For example, other devices and interconnects may alternatively or additionally be used. Accordingly, the exemplary data processing system 100 given in FIG. 1 is not meant to imply architectural limitations with respect to the claimed invention.

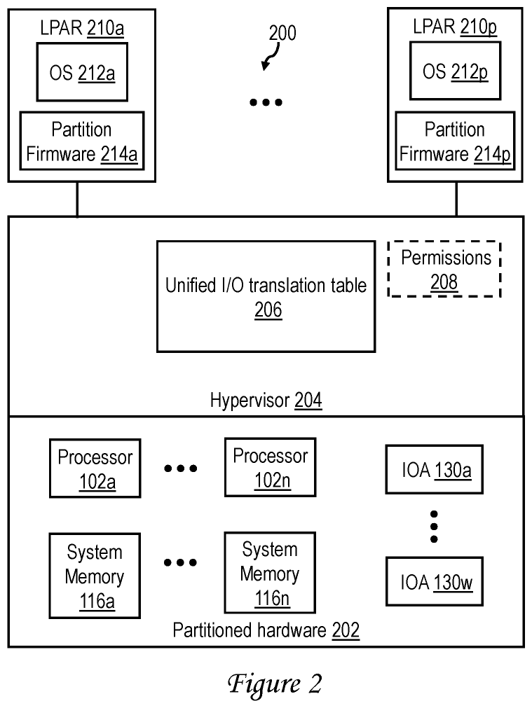

Referring now to FIG. 2, there is depicted a logical view of a data processing system 200 showing the hardware and software resources of the data processing system partitioned into multiple logical partitions (LPARs). Data processing system 200 may have, for example, the same components and/or architecture as data processing system 100 in FIG. 1 and accordingly identifies common components with like reference numerals.

Data processing system 200 has a collection of partitioned hardware 202, including processors 102a-102n (and their respective cores 110, PHBs 120 and other partitionable subcomponents), system memories 116a-116n and IOAs 130a-130w. Partitioned hardware 202 may of course include additional unillustrated components, such as additional volatile or nonvolatile storage devices, ports, bridges, switches, etc. The hardware components comprising partitioned hardware 202 (or portions thereof) can be assigned to various ones of logical partitions (LPARs) 210a-210p in data processing system 200 by system firmware, referred to herein as a hypervisor 204. Hypervisor 204 supports the simultaneous execution of multiple independent operating system instances by virtualizing the partitioned hardware of data processing system 200. In accordance with the disclosed embodiments, hypervisor 204 additionally implements a unified I/O translation data structure (e.g., table) 206 utilized to translate I/O addresses for all of LPARs 210.

In addition to the hardware resources allocated by hypervisor 204, each of LPARs 210a-210p includes a respective one of multiple concurrently executed operating system instances 212a-212p. In various embodiments, operating system instances 212a-212p, which may include, for example, instances of the Linux, Windows, Android, macOS, and/or iOS operating systems, may be homogeneous or heterogeneous. Each LPAR 210 may further include unillustrated application programs, as well as a respective instance of partition firmware 214a-214p, which may be implemented, for example, with a combination of initial boot strap code, IEEE-1275 Standard Open Firmware, and runtime abstraction software (RTAS). When LPARs 210a-210p are instantiated, a copy of boot strap code is loaded onto partitions 210a-210p by hypervisor 204. Thereafter, hypervisor 204 transfers control to the boot strap code, which in turn loads the open firmware and RTAS. The processor(s) 102 assigned to each LPAR 210 then execute the partition firmware 214 of that LPAR 210 to bring up the LPAR 210 and initiate execution of the associated instance of OS 212.

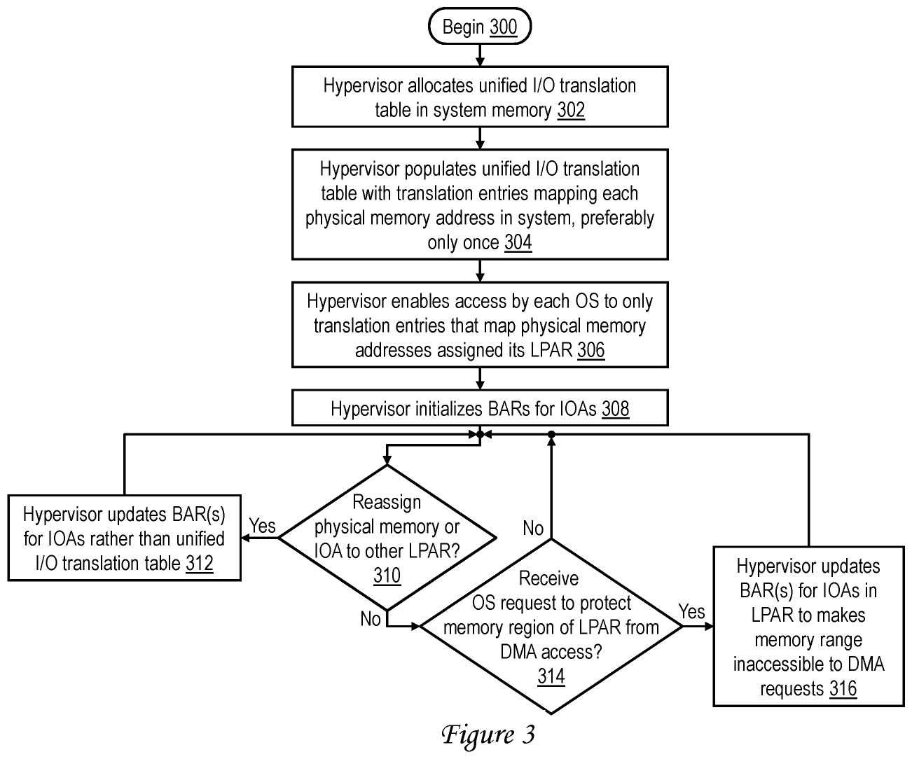

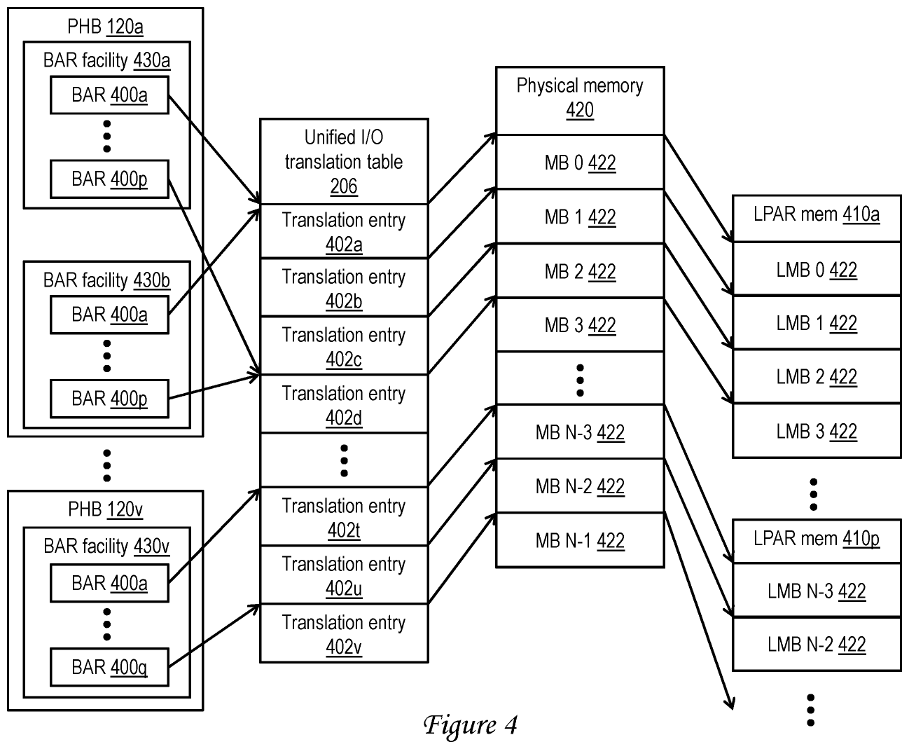

Referring now to FIG. 3, there is illustrated a high-level logical flowchart of an exemplary process by which a hypervisor 204 implements a unified I/O translation table 206 in accordance with one embodiment. The process of FIG. 3 begins at block 300, for example, during the boot of hypervisor 204 on the cores 110 of one or more processors 102. The process of FIG. 3 proceeds from block 300 to block 302, which illustrates hypervisor 204 allocating in the physical memory provided by system memories 116 a unified I/O translation table 206. Preferably, unified I/O translation table 206 is sized by hypervisor 204 to concurrently hold translation entries 402 (see, e.g., FIG. 4) for all of the physical address space collectively presented by system memories 116.

After hypervisor 204 allocates unified I/O translation table 206 within system memories 116 at block 302, hypervisor populates unified I/O translation table 206 with a plurality of translation entries 402 that collectively provide I/O address mappings for all physical memory blocks 422 in data processing system 100 or 200, with each physical memory address preferably being mapped by a single translation entry 402 (block 304). As shown at block 306, hypervisor 204 enables access by each OS 212 to only those translation entries within unified I/O translation table 206 that map physical memory addresses assigned by hypervisor 204 to its LPAR 210. In some embodiments, these OS access permissions can be stored by hypervisor 204 within unified I/O translation table 206; in other embodiments, these OS access permissions can be stored within a separate associated set of permissions 208. Hypervisor 204 additionally configures IOAs 130 for use by initializing, in the relevant PHB 120, a respective base address register (BAR) facility 430 (see, e.g., FIG. 4) for each IOA 130 (block 308). In particular, for each IOA 130, hypervisor 204 configures each BAR 400 (see, e.g., FIG. 4), which is associated with a respective decoding of I/O addresses, with an address pointer to a corresponding translation entry 402 in unified I/O translation table 206.

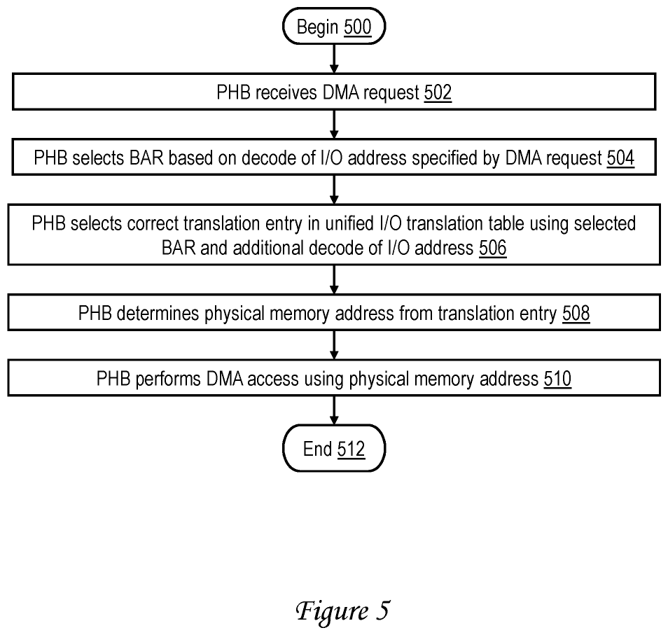

Following block 308, LPARs 210 are permitted to make DMA accesses to system memories 116 by reference to unified I/O translation table 206, as described in greater detail below with reference to FIG. 5. It should be noted that following block 308, OSs 212 preferably do not issue to hypervisor 206, and hypervisor 206 preferably does not service, any requests to unmap or remap any of the translation entries 402 in unified I/O translation table 206. Rather, as indicated at block 310 and 312, if the hypervisor 204 determines to reassign a region of physical memory or one of IOAs 130 to a different LPAR 210, hypervisor 204 updates the BAR(s) 400 for the IOAs 130 of the affected LPAR(s) 210 in order to ensure the IOAs 130 of each LPAR 210 can only access the regions of physical memory assigned to each LPAR 210.

Block 314 further illustrates that an OS 212 may have regions of physical memory that it desires to protect against DMA access, such as the kernel space storing the operating system kernel. Accordingly, the OS 212 may issue a request to hypervisor 204 to protect a memory region assigned to its LPAR 210 from access by DMA requests. In response to receipt by hypervisor 204 of a request by an OS 212 to protect one of its assigned memory regions in physical memory from DMA requests, hypervisor 204 updates the BAR facilities 430 for IOAs 130 assigned to the LPAR 210 of the requesting OS 212 to make memory region inaccessible to DMA requests (block 316). Following block 312 or block 316, the process of FIG. 3 returns to block 310.

Referring now to FIG. 4, there is depicted a block diagram illustrating I/O address translation by reference to a unified I/O translation table 206 in accordance with one embodiment. In the depicted example, unified I/O translation table 206 includes a plurality of translation entries 402a-402v, each configured by hypervisor 204 in accordance with the process of FIG. 3 to provide an I/O address-to-physical address translation for a respective corresponding one of N memory blocks 422 of physical memory 420 formed by system memories 116. As further illustrated, these physical memory blocks 422 are allocated by hypervisor 204 to various LPARs 210 as logical memory blocks (LMBs) 422. For example, in the illustrated case, hypervisor 204 has allocated to LPAR 110a an LPAR memory 410a including LMB 0 422 to LMB 3 422, has allocated to LPAR 110p an LPAR memory 410p including LMB N-3 422 and LMB N-2 422, and has allocated to yet another LPAR 110 an unillustrated LPAR memory including LMB N-1 422.

In the depicted embodiment, each PHB 120 includes a BAR facility 430 for each of its associated IOA slots. Thus, for example, PHB 120a includes at least a BAR facility 430a for IOA 130a and a BAR facility 430b for IOA 130b. Each of BAR facilities 430a and 430b has respective BARs 400a to 400p. Similarly, PHB 120v includes at least a BAR facility 430v for IOA 130v, where BAR facility 430v includes BARs 400a to 400q. In the illustrated example, it is assumed that IOAs 130a and 130b are allocated to the same LPAR 210. Consequently, BARs 400a to 400p in each of BAR facilities 430a and 430b are identically configured by hypervisor 204 to point to the same translation entries 402 (e.g., at least translation entries 402a and 402d) in unified I/O translation table 206. On the other hand, BARs 400a-400q in BAR facility 430v, which provides I/O address translations for a different LPAR 210, point to other translation entries 402 in unified I/O translation table 206, including translation entries 402t and 402v.

With reference now to FIG. 5, there is illustrated a high-level logical flowchart of an exemplary process of translating an I/O address by reference to a unified I/O translation table 206 in accordance with one embodiment. The process of FIG. 5 begins at block 500 and then proceeds to block 502, which illustrates a PHB 120 receiving from an initiating IOA 130 a DMA request, which specifies an I/O address to be accessed (e.g., read or written). In response to receiving the DMA request, the PHB 120 decodes the I/O address to select a particular BAR 400 in the BAR facility 430 associated with the initiating IOA 130 (block 504). PHB 120 then selects the relevant translation entry 402 in unified I/O translation table 206 based on the address pointer contained in the selected BAR 400, and optionally, an additional decode of the I/O address (block 506). PHB 120 can then determine the physical memory address based on the I/O address-to-physical address translation stored in the selected translation entry (block 508). Utilizing the physical address obtained by the address translation performed at block 508, PHB 120 performs the DMA access requested by the DMA request (block 510). Thereafter, the process of FIG. 5 ends at block 512.

As has been described, in at least one embodiment, a data processing system establishes a unified input/output (I/O) translation table including a plurality of translation entries for translating between I/O addresses and memory addresses. The unified I/O translation table can be established in physical memory of the data processing system, for example, by execution of a hypervisor. I/O addresses specified by direct memory access (DMA) requests received from different I/O adapters each allocated to respective different logical partitions (LPARs) are translated by reference to translation entries in the unified I/O translation table. Physical memory of the data processing system is then accessed based on memory addresses determined by the translation.

In at least one embodiment, the unified I/O translation table is concurrently populated with translation entries sufficient to translate all physical memory addresses in the data processing system.

In at least one embodiment, in response to receiving a particular DMA request initiated by a particular I/O adapter, a base address register (BAR) among a plurality of BARs associated with the particular I/O adapter is selected based on a decode of a particular I/O address specified by the particular DMA request. Based on an address pointer within the BAR, a translation entry among the plurality of translation entries with which to translate the particular I/O address is selected.

In at least one embodiment, based on reassignment of physical memory between LPARs, the address pointer in a BAR is updated.

In at least one embodiment, the relevant BAR for a given DMA request is selected by an I/O host bridge.

In at least one embodiment, multiple different LPARs concurrently executing in a data processing system include a particular LPAR to which a particular I/O adapter among the different I/O adapters is allocated. The particular I/O adapter has an associated plurality of BARs storing address pointers to translation entries in the unified I/O translation table. Based on a request by the an operating system of the particular LPAR to protect a memory region of physical memory allocated to the particular LPAR, at least one of the plurality of BARs is updated to make the memory region inaccessible to DMA requests.

In at least one embodiment, after the unified I/O translation table is established, the data processing system refrains from updating translation entries in the unified I/O translation table.

The disclosed inventions provide numerous advantages and improvements in the operation of a data processing system. First, because the hypervisor pre-maps each page of physical memory prior to DMA access and then maintains static I/O address-to-physical address translations, the I/O latency incurred in prior art systems due to mapping, clearing, and re-mapping of I/O address translations is eliminated. Second, hardware cache invalidation operations required in prior art systems because of the re-mapping of I/O address translations are eliminated, increasing available cache memory and interconnect bandwidth. Third, complex per-slot I/O translation table size calculations employed in prior art systems are avoided, making the memory utilization due to the unified I/O translation tables readily determined and understood. Fourth, the hypervisor memory footprint is reduced as compared to prior art system by virtue of implementation of a unified I/O translation table instead of a separate I/O translation table per I/O slot. Fifth, each and every physical memory address is preferably mapped in the unified I/O translation table, eliminating the need for special paths to enable larger I/O translation tables for specific I/O slots.

The present invention may be implemented as a method, a system, and/or a computer program product. The computer program product may include a storage device having computer readable program instructions (program code) thereon for causing a processor to carry out aspects of the present invention. As employed herein, a “storage device” is specifically defined to include only statutory articles of manufacture and to exclude signal media per se, transitory propagating signals per se, and energy per se.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Aspects of the present invention are described herein with reference to flowchart illustrations and/or block diagrams that illustrate the architecture, functionality, and operation of possible implementations of systems, methods, and computer program products according to various embodiments. It will be understood that each block of the block diagrams and/or flowcharts and combinations of blocks in the block diagrams and/or flowcharts can be implemented by special purpose hardware-based systems and/or program code that perform the specified functions. While the present invention has been particularly shown as described with reference to one or more preferred embodiments, it will be understood by those skilled in the art that various changes in form and detail may be made therein without departing from the spirit and scope of the invention.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of data processing in a data processing system, the method comprising:
a processor establishing a unified input/output (I/O) translation table, wherein the unified I/O translation table includes a plurality of translation entries for translating between I/O addresses and memory addresses;
translating I/O addresses specified by direct memory access (DMA) requests received from different I/O adapters each allocated to respective different logical partitions (LPARs) by reference to translation entries in the unified I/O translation table; and
performing accesses to physical memory of the data processing system based on memory addresses determined by the translating.

2. The method of claim 1, wherein:
the establishing includes concurrently populating the unified I/O translation table with translation entries sufficient to translate all physical memory addresses in the data processing system.

3. The method of claim 1, wherein the translating includes:
in response to receiving a particular DMA request initiated by a particular I/O adapter, selecting a base address register (BAR) among a plurality of BARs associated with the particular I/O adapter based on a decode of a particular I/O address specified by the particular DMA request; and
selecting, based on an address pointer within the BAR, a translation entry among the plurality of translation entries with which to translate the particular I/O address.

4. The method of claim 3, further comprising:
based on reassignment of physical memory between LPARs, the processor updating the address pointer in the BAR.

5. The method of claim 3, wherein selecting the BAR includes an I/O host bridge selecting the BAR.

6. The method of claim 1, wherein:
the multiple different LPARs include a particular LPAR to which a particular I/O adapter among the different I/O adapters is allocated;
the particular I/O adapter has an associated plurality of base address registers (BARs) storing address pointers to translation entries in the unified I/O translation table;
the particular LPAR includes an operating system; and
the method further comprises:
based on receiving a request by the operating system to protect a memory region of physical memory allocated to the particular LPAR, updating at least one of the plurality of BARs to make the memory region inaccessible to DMA requests.

7. The method of claim 1, further comprising:
after the establishing, refraining from updating translation entries in the unified I/O translation table.

8. A data processing system, comprising:
a processor core;
physical memory communicatively coupled to the processor core, wherein the physical memory stores a unified input/output (I/O) translation table including a plurality of translation entries for translating between I/O addresses and memory addresses;
one or more I/O host bridges communicatively coupled to the physical memory, wherein the one or more I/O host bridges are configured to perform:
translating I/O addresses specified by direct memory access (DMA) requests received from different I/O adapters each allocated to respective different logical partitions (LPARs) by reference to translation entries in the unified I/O translation table; and
performing accesses to physical memory of the data processing system based on memory addresses determined by the translating.

9. The data processing system of claim 8, wherein the unified I/O translation table is concurrently populated with translation entries sufficient to translate all physical memory addresses in the data processing system.

10. The data processing system of claim 8, wherein the translating includes:
in response to receiving a particular DMA request initiated by a particular I/O adapter, selecting a base address register (BARs) among a plurality of BARs associated with the particular I/O adapter based on a decode of a particular I/O address specified by the particular DMA request; and
selecting, based on an address pointer within the BAR, a translation entry among the plurality of translation entries with which to translate the particular I/O address.

11. The data processing system of claim 10, wherein the processor core is configured to perform:
based on reassignment of physical memory between LPARs, updating the address pointer in the BAR.

12. The data processing system of claim 8, wherein:
the multiple different LPARs include a particular LPAR to which a particular I/O adapter among the different I/O adapters is allocated;
the particular I/O adapter has an associated plurality of base address registers (BARs) storing address pointers to translation entries in the unified I/O translation table;
the particular LPAR includes an operating system; and
the processor core is configured to perform:
based on receiving a request by the operating system to protect a memory region of physical memory allocated to the particular LPAR, updating at least one of the plurality of BARs to make the memory region inaccessible to DMA requests.

13. The data processing system of claim 8, wherein the translation entries in the unified I/O translation table are static.

14. A program product, comprising:
a storage device; and
program code stored in the storage device that, when executed by a processor of a data processing system, causes the data processing system to perform:
establishing a unified input/output (I/O) translation table, wherein the unified I/O translation table includes a plurality of translation entries for translating between I/O addresses and memory addresses;
translating I/O addresses specified by direct memory access (DMA) requests received from different I/O adapters allocated to multiple different logical partitions (LPARs) by reference to translation entries in the unified I/O translation table; and
performing accesses to physical memory of the data processing system based on memory addresses determined by the translating.

16. The program product of claim 14, wherein:
the establishing includes concurrently populating the unified I/O translation table with translation entries sufficient to translate all physical memory addresses in the data processing system.

17. The program product of claim 14, wherein the translating includes:
in response to receiving a particular DMA request initiated by a particular I/O adapter, selecting a base address register (BAR) among a plurality of BARs associated with the particular I/O adapter based on a decode of a particular I/O address specified by the particular DMA request; and
selecting, based on an address pointer within the BAR, a translation entry among the plurality of translation entries with which to translate the particular I/O address.

18. The program product of claim 17, wherein the program code further causes the data processing system to perform:
based on reassignment of physical memory between LPARs, updating the address pointer in the BAR.

19. The program product of claim 14, wherein:
the multiple different LPARs include a particular LPAR to which a particular I/O adapter among the different I/O adapters is allocated;
the particular I/O adapter has an associated plurality of base address registers (BARs) storing address pointers to translation entries in the unified I/O translation table;
the particular LPAR includes an operating system; and
the program code causes the data processing system to further perform:
based on receiving a request by the operating system to protect a memory region of physical memory allocated to the particular LPAR, updating at least one of the plurality of BARs to make the memory region inaccessible to DMA requests.

20. The program product of claim 14, the program code causes the data processing system to further perform:
after the establishing, refraining from updating translation entries in the unified I/O translation table.
